(19) United States
(12) Patent Application Publication
(10) Pub. No.: US 2007/0062163 A1
(43) Pub. Date: Mar. 22, 2007

(54) Inserter

(75) Inventors: Edward J. Cook, Scarborough (CA); Paul J. Connelly, Scarborough (CA)

Correspondence Address: MICHAEL BEST & FRIEDRICH, LLP, 100 E WISCONSIN AVENUE, MILWAUKEE, WI, 53202, US

(73) Assignee: Longford International Ltd., Scarborough (CA)

(21) Appl. No.: 11/232,608

(22) Filed: Sep. 22, 2005

(51) Int. Cl. B65B 43/26; B67B 7/00

(52) U.S. Cl. 53/492; 53/381.6

(57) ABSTRACT

An envelope stuffer has a carrousel with opposed first and second side walls and a plurality of envelope receivers. A pair of opposed abutments are supported inwardly of the first and second carrousel side walls and extend along an arc of the first and second carrousel side walls. An upstream end of at least one abutment of the pair of abutments flare outwardly away from the other abutment of the pair. An envelope flap folder has a plough and a pivoting plate upstream of the plough. The pivoting plate has a first position establishing a first flap feed path which bypasses the plough and a second position establishing a second flap feed path which incorporates the plough. An actuator is also provided for pivoting the plate between the first position and the second position.

### BACKGROUND

This invention relates to stuffing and folding envelopes.

Gift cards are increasingly prevalent and are often sold in sealed envelopes which include a sheet of terms and conditions and, possibly, sheets of advertising material. Gift cards may come in various denominations such as $20, $50, or $100 and the denomination of the card is typically printed on its envelope. In view of the potential value of a gift card containing envelope, it is important that the gift card in an envelope actually be for the denomination printed on the envelope. It is also important that the terms and conditions be provided. Gift card containing envelopes may be manually assembled, but this is time consuming.

This invention therefore seeks to provide an approach for more efficiently stuffing and/or folding envelopes, which may be gift card containing envelopes.

### SUMMARY OF INVENTION

An envelope stuffer has a carrousel with opposed first and second side walls and a plurality of envelope receivers. A pair of opposed abutments are supported inwardly of the first and second carrousel side walls and extend along an arc of the first and second carrousel side walls. An upstream end of at least one abutment of the pair of abutments flare outwardly away from the other abutment of the pair.

In another aspect, an envelope may be fed into an envelope receiver of a carrousel, where the carrousel has opposed first and second side walls and a plurality of envelope receivers. The carrousel may be rotated so that edges of the envelope are contacted by a pair of opposed abutments supported inwardly of the first and second carrousel side walls. Consequently, the edges are held inwardly deflected so that the envelope is opened and inserts may be fed into the envelope while it is opened.

In a further aspect, an envelope flap folder comprises a plough and a pivoting plate upstream of the plough. The pivoting plate has a first position establishing a first flap feed path which bypasses the plough and a second position establishing a second flap feed path which incorporates the plough. An actuator is also provided for pivoting the plate between the first position and the second position.

Other features and advantages will be apparent from the following description in conjunction with the drawings.

### BRIEF DESCRIPTION OF THE DRAWINGS

In the figures which illustrate an example embodiment of the invention,

FIG. 1 is a schematic plan view of a system made in accordance with this invention,

FIG. 2A is a left side perspective view of the carrousel of FIG. 1,

FIG. 2B is a detail view of a portion of FIG. 2A,

FIG. 2C is a right side perspective view of the carrousel,

FIG. 2D is a top view of the carrousel,

FIG. 2E is a left side view of the carrousel,

FIG. 2F is a fragmentary front view of a portion of the carrousel and envelope loading conveyor of FIG. 1,

FIG. 3 is a back perspective view of the envelope unloading conveyor of FIG. 1,

FIG. 4 is a front perspective view of the selective flap folding section of the envelope unloading conveyor, and

FIGS. 5A and 5B are schematic views of the selective flap folding section.

### DETAILED DESCRIPTION

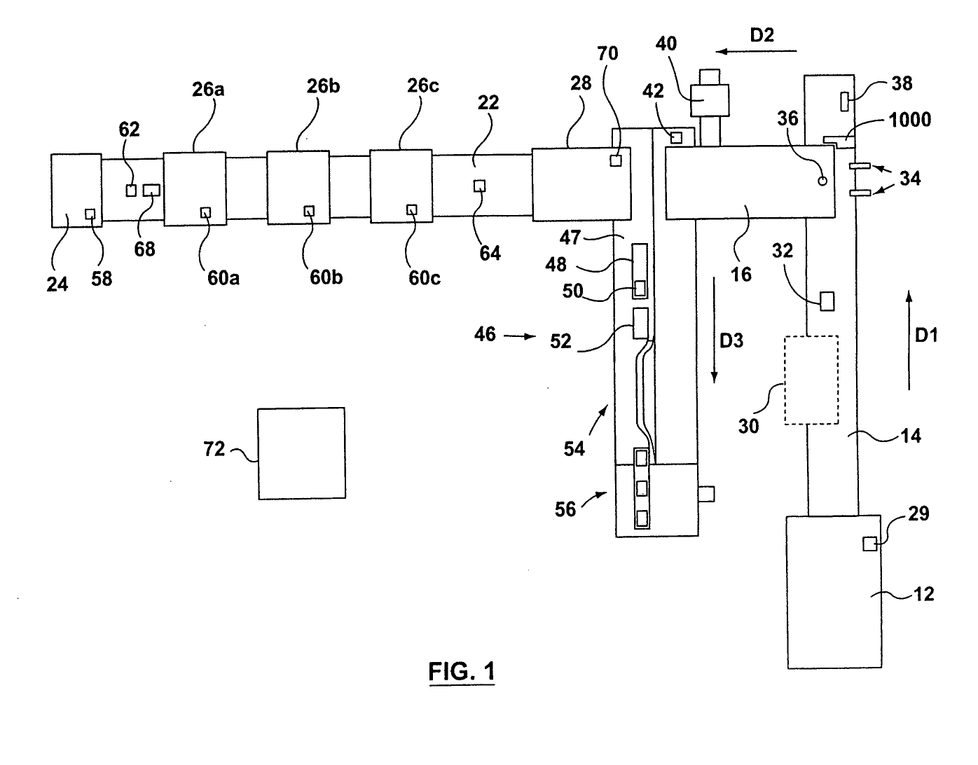

With reference to FIG. 1, an envelope stuffing system 10 may comprise, in downstream order, D1, D2, D3, an envelope feeder 12, an envelope loading conveyor 14, carrousel 16, and an envelope unloading conveyor 18. The carrousel may be aligned with the output of an insert dispenser 28. The insert dispenser 28 may be at the downstream end of an insert conveyor 22. There may be a card feeder 24 at the upstream end of the insert conveyor and the insert conveyor may also have associated with it, in downstream order, D4, three serially arranged insert feeders 26a, 26b, 26c.

The envelope feeder 12 may have an associated envelope sensor 29. The envelope loading conveyor 14 may have an associated printer 30, reader 32, air jets 34, vacuum cup 36, envelope arrester 1000, and conveyor position sensor 38. Carrousel 16 may be indexed by a motor 40 with a rotary encoder. The envelope unloading conveyor 18 may have a conveyor position sensor 42, selective envelope flap folding station 46, a progressive folding station 54, and a sealing section 56.

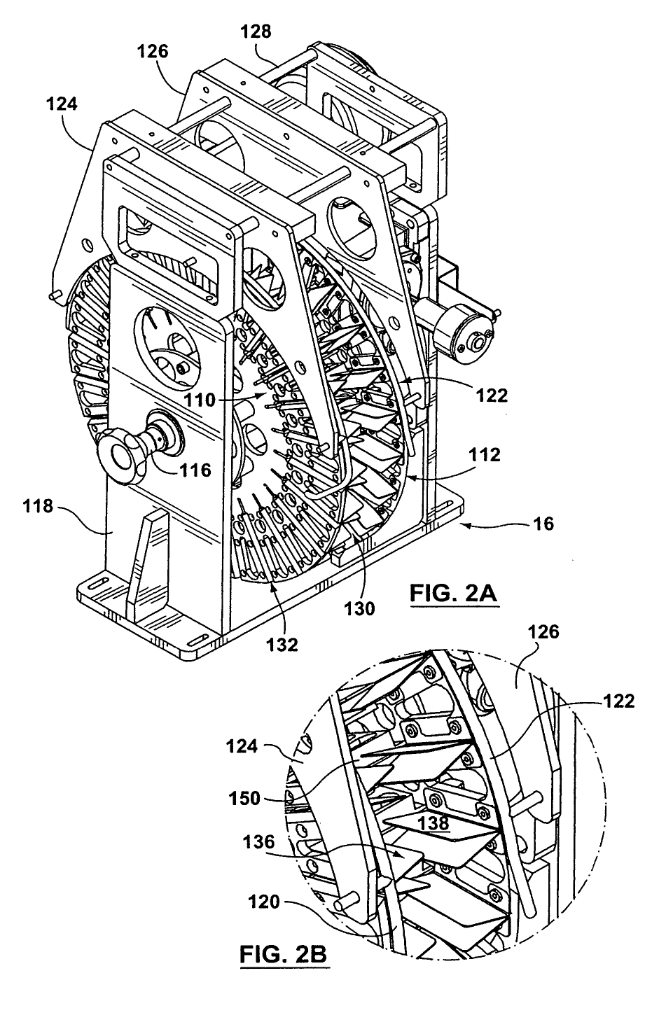

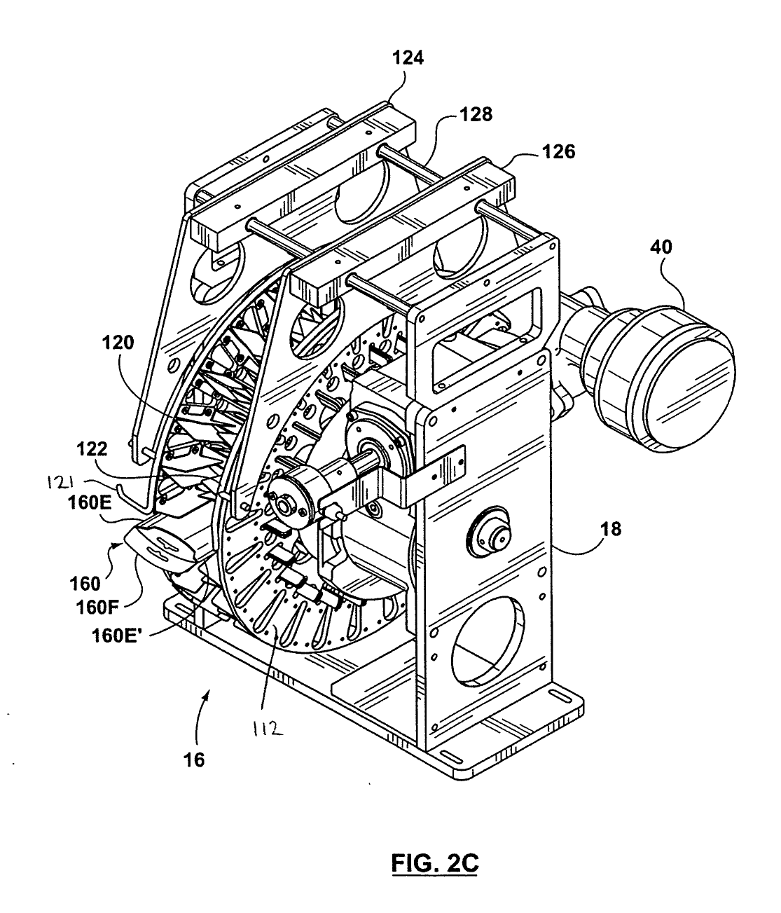

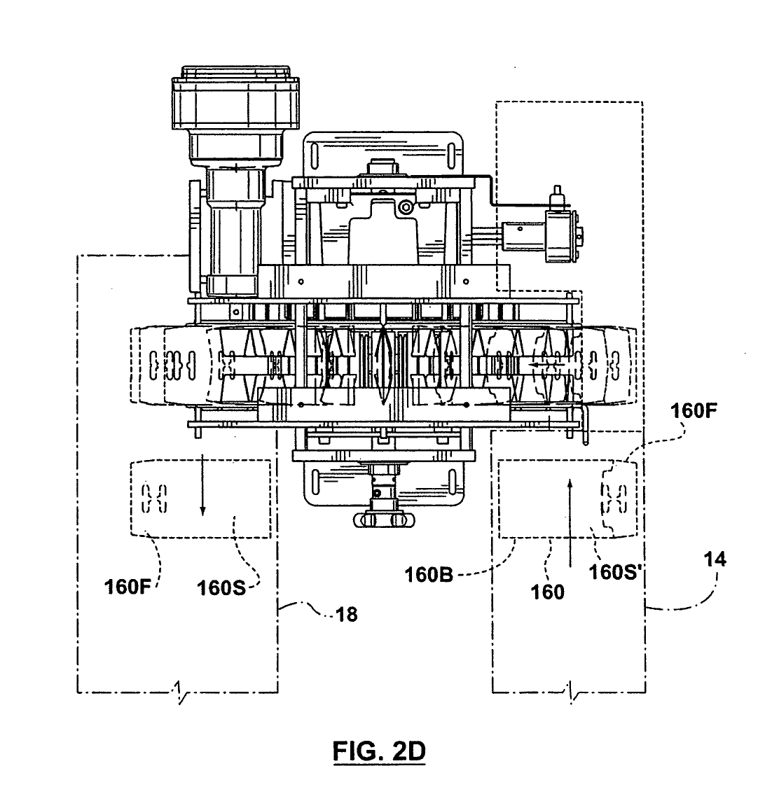

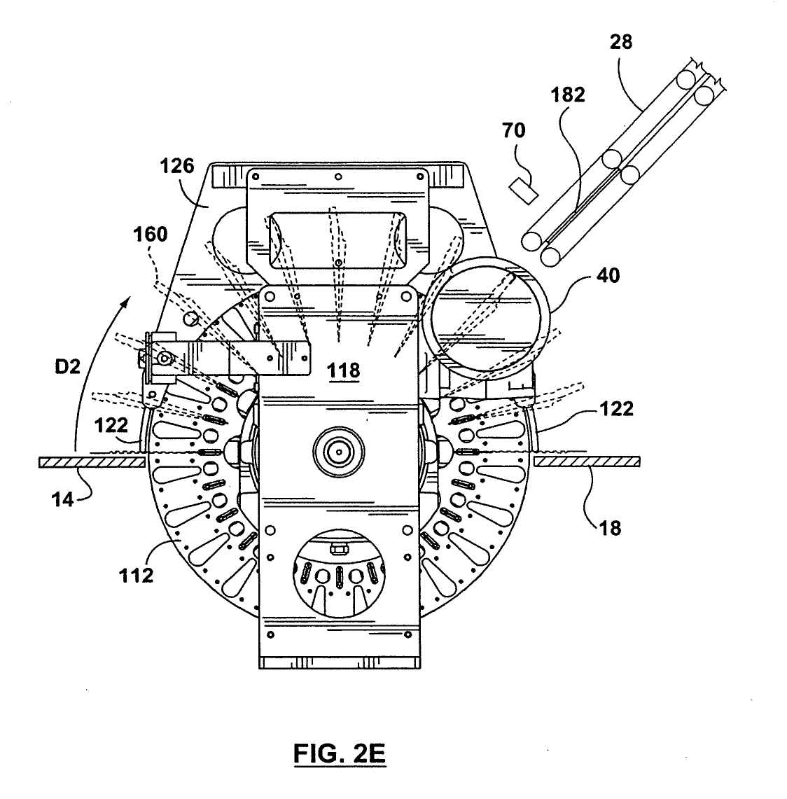

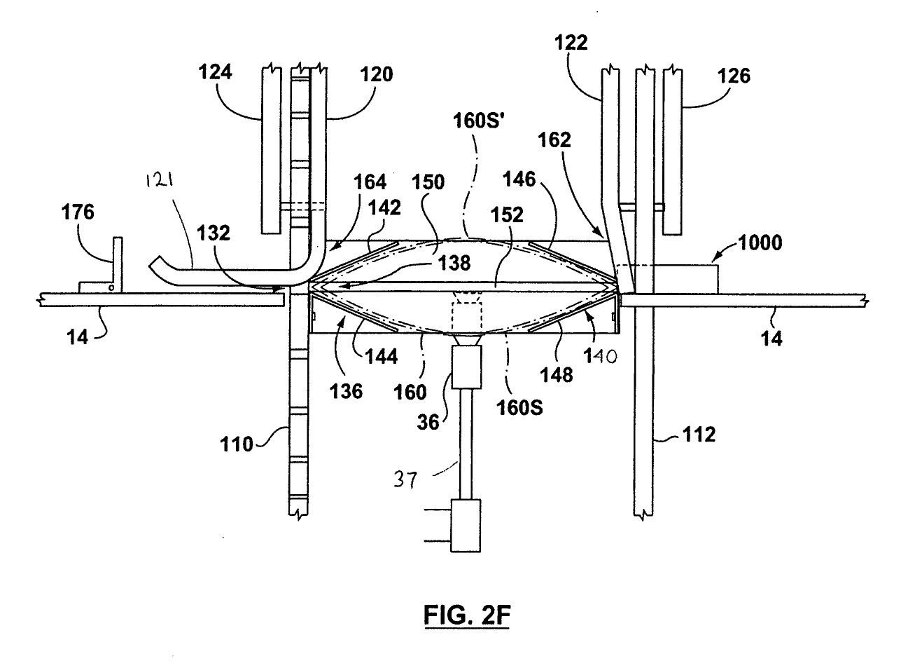

The card feeder 24 and each insert feeder 26a, 26b, 26c may have an associated insert sensor 58, and 60a, 60b, 60c, respectively. Additionally, the insert conveyor 22 itself may have an associated sensor 62 between the card feeder 24 and the first insert feeder 26a as well as sensor 64 downstream of insert feeder 26c. A reader 68 may also be associated with the insert conveyor 22 between the card feeder 24 and the first insert feeder 26a. A final sensor 70 may be associated with the downstream end of the insert dispenser 28. As shown in FIG. 2E, the insert dispenser may comprise a pair of parallel feed belts which will compress any stack 182 of inserts therebetween so as to be able to positively feed the stack of inserts.

A processor 72 is connected to the output of readers 32, 68; sensors 29, 38, 42, 58, 60a, 60b, 60c, 62, 64, and 70; and the rotary encoder of motor and rotary encoder 40. Additionally, the processor has a control input to printer 30, motor 40, solenoid 50, the motors (not shown) for the conveyors 14 and 18, the card feeder 24, the insert feeders 26a, 26b, 26c, and the insert dispenser 28.

The conveyors may be lug conveyors. The sensors may be photocells which output a “sensed” signal when interrupted.

Turning to FIGS. 2A to 2F which detail the carrousel, the carrousel 16 may have opposed first and second disc-shaped side walls 110, 112 axially mounted on a shaft 116 supported by a frame 118 for rotation. Motor 40 for rotating the carrousel may also be supported by the frame. A pair of opposed abutments 120, 122 may be supported by arms 124, 126 which slide on rods 128 mounted to frame 118 so that, apart from the upstream end of abutment 120 which terminates in a foot 121, the abutments are positioned laterally between the first and second carrousel side walls 110, 112. The abutments may be curved rods which extend along an arc of the carrousel. A plurality of radially directed envelope receivers 130 may be supported by the carrousel side walls 110, 112: the first side wall 110 of the carrousel may have a radial slot 132 aligned with each of these envelope receivers. As best seen in FIG. 2F, each envelope receiver may comprise a first V-shaped envelope support 136 extending inwardly from the first side wall 110 and narrowing toward the first side wall with a narrow end of the first envelope support defining a gap 138 aligned with a slot 116. An envelope receiver may also have a second V-shaped envelope support 140 opposed to the first V-shaped envelope support and extending inwardly from the second side wall 112. The first envelope support 136 may comprise a pair of plates 142, 144 and the second envelope support may also comprise a pair of plates 146, 148.

Each envelope receiver may also have a base 150 which extends between the first and second carrousel side walls. The base 150 may define a slot 152 for confining and supporting a base of an envelope 160.

As seen in FIG. 2F, vacuum cup 36 is mounted on a reciprocating piston 37.

The carrousel may be rotationally indexed by motor 40 in downstream direction D2 so that any envelope receiver 130 at the level of the loading conveyor 14 rotates upwardly. The upstream end of the abutments 120, 122 may terminate at the loading conveyor 14 such that envelopes 160 conveyed by the carrousel away from said loading conveyor are conveyed between the abutments.

The upstream end 162 of abutment 122 may flare outwardly from abutment 120 by virtue of a bend in abutment 122. The upstream end 164 of abutment 120 may flare outwardly from abutment 120 and terminate in foot 121 which overlies envelope loading conveyor 14.

As best seen in FIG. 2E, the curved abutments 120, 122 may extend along an arc of the carrousel side walls 110, 112 between the envelope loading conveyor 14, past the insert dispenser 28, to the envelope unloading conveyor 18.

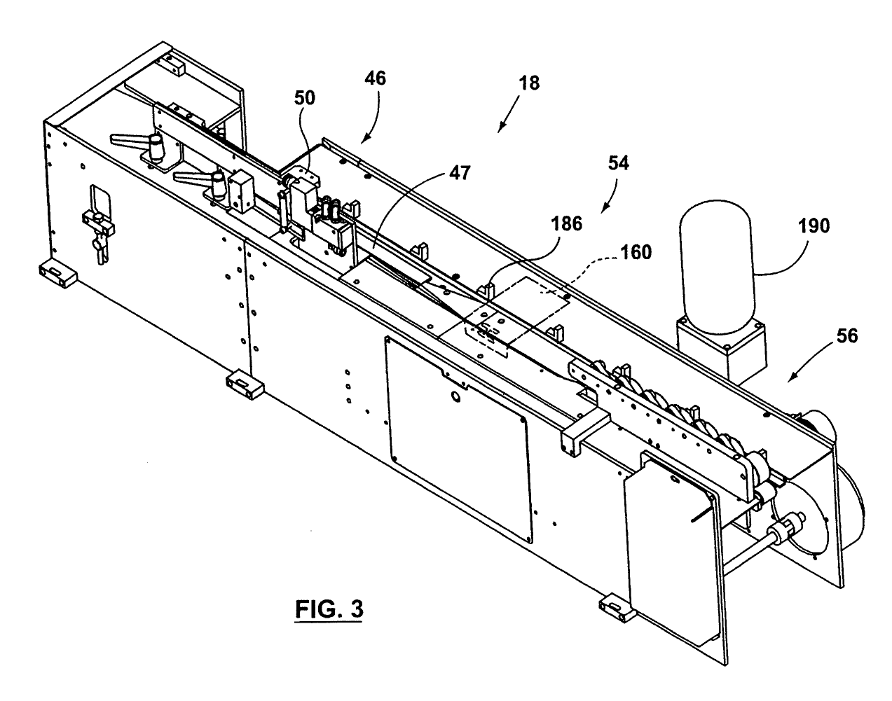

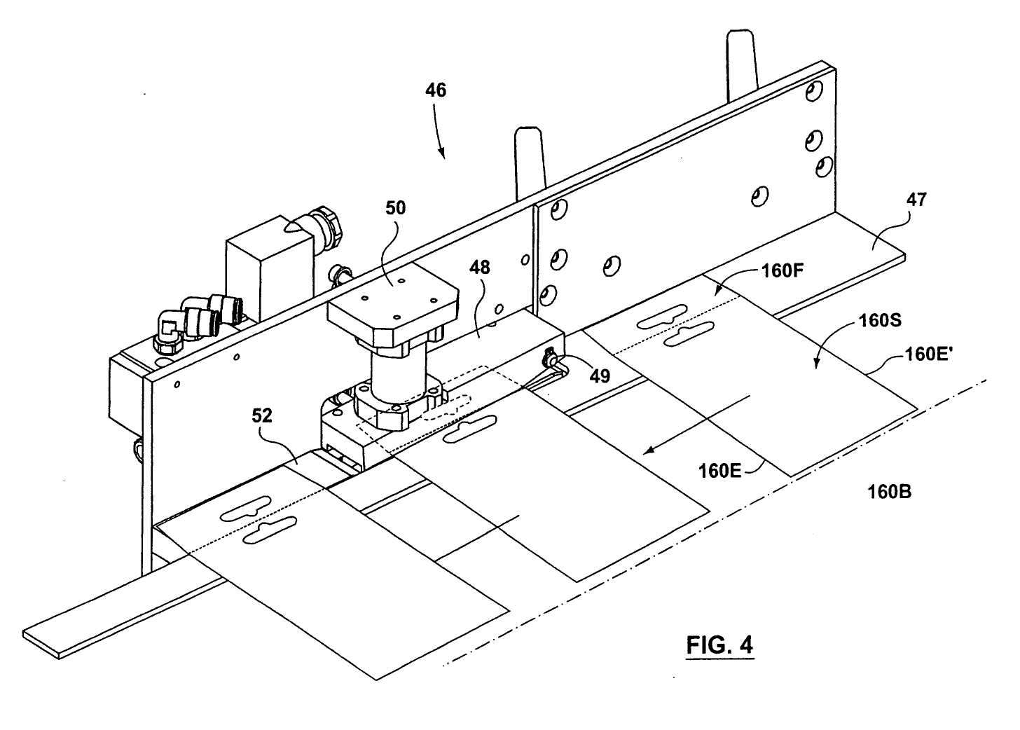

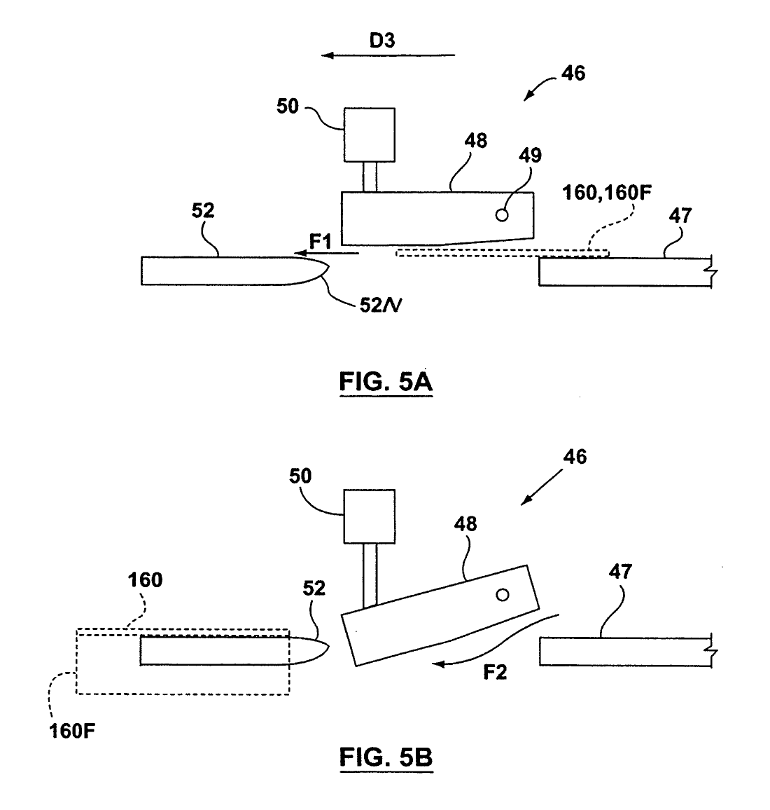

Turning to FIG. 3, lugs 186, but not the connecting chain, of envelope unloading conveyor 18 are shown. The envelope unloading conveyor may have a stationary support ledge 47. The progressive folding station 54 may include a water supply 190 and the sealing station 56 may comprise a series of nip rollers 192. Referencing FIG. 4 along with FIG. 3, the selective flap folding station 46 of unloading conveyor 18 may have a pivot plate 48 pivoted about pivot pin 49 by a solenoid 50. Station 46 may also have a plough 52. Turning to FIGS. 5A and 5B, plough 52 has flat top and bottom surfaces but an upstream plough-shaped nose 52n. When pivot plate 48 is in a first position illustrated in FIG. 5A, the bottom surface of the plate 48 is parallel to, and above, the flat top surface of the support ledge 47 and the flat top surface of plough 52. Solenoid 50 may move pivot plate 48 from this first position to a second position illustrated in FIG. 5B wherein the bottom surface of the pivot plate at its downstream end is proximate or below the bottom surface of the plough 52.

Returning to FIG. 1 and FIG. 2D, to prepare system 10 for operation, assuming it lacks printer 30, a stack of pre-printed envelopes 160 may be loaded to envelope feeder 12 with their flaps 160F open, with the flap bearing back side 160S of the envelope at the bottom of the envelope, and with the base 160B of the envelope at the carrousel side of the envelope feeder. A stack of gift cards may be loaded to card feeder 24. The stacks are ordered with the intention that a card at a given position in the card stack will be inserted into an envelope in that same position in the envelope stack. A stack of inserts may be loaded to each of the insert feeders 26a, 26b, 26c such that each insert feeder feeds a different insert. The envelopes may be pre-printed with human readable indicia, including an indication of the monetary value of a gift card. The envelopes may also be pre-printed with a bar code and/or the envelopes may have a magnetic stripe encoded with information which may uniquely identify the envelope.

In operation, envelopes may be serially fed from the envelope feeder 24 such that an envelope is fed between each pair of lugs of the envelope loading conveyor 14. With brief reference to FIG. 2D, because of the orientation of each envelope in the envelope feeder, each envelope on the envelope loading conveyor has its base 160B at the carrousel side of the loading conveyor and its flap 160F open, with the back side 160S of the envelope to which the flap is hinged lying against the loading conveyor. Sensor 29 sends a signal to processor 72 to confirm the feeding of each envelope. As an envelope passes reader 32, encoded information on the envelope may be read and passed to processor 72. The processor is able to track the progress of each envelope on the envelope loading conveyor by virtue of conveyor position sensor 38.

Turning to FIGS. 2A to 2F, as an envelope reaches carrousel 16, the base 160B of the envelope slides through a radial slot 132 of the first side 110 of the carrousel and into an envelope receiver 130, stopping when an edge of the envelope abuts block 1000 and curved abutment 122. As is known, the base of the backward L-shaped lug 176 (FIG. 2F) of the envelope loading conveyor 14 which is propelling the envelope into the carrousel may drop off its supporting ledge just as the edge of the envelope abuts block 1000 and curved abutment 121 so that the lug flips back out of the way. Vacuum cup 36 and air jets 34 (FIG. 1) may be triggered by the arrival of the envelope (as, for example, by the processor which is tracking progress of the envelope or locally by the envelope interrupting a photocell or a switch switching responsive to the falling away of the lug). The air jets force air into the throat of the envelope between the front 160S′ and back 160S sides of the envelope. Further, the vacuum applied through vacuum cup 36 grips the back side 160S of the envelope so that the back side 169s may be pulled downwardly as piston 37 retracts. The result is that envelope opens up as shown in FIG. 2C, drawing the edges 160E, 160E′ of the envelope toward each other. The V-shaped envelope supports 136, 138 set an upper limit on the degree to which an envelope will open up.

At this stage, processor 72 may control motor 40 to index the carrousel in the downstream feed direction D2. This moves the edges 160E, 160E′ of the envelope between the abutments 120, 122 which abutments have their upstream ends at the envelope loading conveyor 14. The outwardly flaring ends 162, 164 of the abutments assist in ensuring the envelope edges are captured between these abutments. With the abutments constraining the envelope edges, and thereby keeping the envelope opened up, the air jets and vacuum cup are no longer required for this purpose and they may be shut down until the next envelope arrives. Each time the carrousel indexes in the downstream direction, the envelopes within the carrousel progress toward the envelope unloading conveyor 18. Because of the rotary encoder on carrousel motor 40, the processor 72 can track the progress of an envelope in the carrousel. Each time the carrousel indexes, a new envelope receiver 130 becomes aligned with the discharge end 180 of the insert dispenser 28. As will be further described hereinafter, when an envelope reaches the insert dispenser, the processor can send a demand signal to the insert dispenser causing it to dispense an insert stack into the envelope.

An envelope, filled with inserts then indexes down to the envelope unloading station. In this regard, it will be noted that the downstream end of the abutments 120, 122 end just above the unloading conveyor 18, such that an envelope is allowed to relax as it reaches the unloading conveyor. It will be noted that an envelope, by virtue of rotating through about 180° as it moves from the loading conveyor to the unloading conveyor ends up with its flap bearing back side 160S facing upwardly on the unloading conveyor.

Turning to FIGS. 3 to 5, when an envelope reaches the unloading conveyor 18, a lug 186 on the conveyor pushes the envelope from the carrousel and the envelope now progresses to the selective flap folding section 46 of the unloading conveyor. If the processor 72 controls the solenoid 50 such that the pivot plate is in its first position as shown in FIGS. 4 and 5A, then there is a feed path F1 for the flap of the envelope between the top surface of the stationary support ledge 47 of the unloading conveyor and the top surface of the plough 52 on the one hand and the bottom surface of the pivot plate 48 on the other. In consequence, the flap moves through the selective flap folding section 46 without being urged closed. On the other hand, if the processor 72 controls the solenoid 50 such that the pivot plate is in its second position as shown in FIG. 5B, then a feed path F2 is established for the flap 160F along the bottom surface of the pivot plate 48 and the bottom surface of the plough 52. In consequence, the flap is urged to fold downwardly toward a vertical position. The sensor 42 on the unloading conveyor 18 allows the processor to track envelopes on the unloading conveyor so that the processor can leave selected envelopes open.

If a flap is folded down in the selective flap folding section 46, then it is entrained by the progressive folding section 54. This section progressively folds the flap toward the front side 160S′ of the envelope, with sealing section 56 then sealing the flap to the front side of the envelope. In this regard, the flap may be provided with a pressure sensitive adhesive. Alternatively, a wetting station supplied by water supply 190 may be provided in conjunction with the progressive folding section 54 in order to wet the adhesive of the flap so that the flap may be sealed by the nip rollers 192 at the sealing section 56.

As envelopes are progressing in system 10, so are the inserts. On demand from the processor 72, cards are fed from the card feeder 24 to the insert conveyor 22. Sensor 58 signals processor 72 on each card being fed. A fed card is read by reader 68 with the information read being passed to the processor. As a card progresses along the insert conveyor, the processor tracks it progress. Optionally, based on the information read from the card, as the card passes an insert feeder 26a, 26b, 26c, the processor may send a demand to the insert feeder causing the feeding of an insert. Sensor 60a, 60b, or 60c will signal the processor when an insert is fed from the respective insert feeder. Sensor 64 will confirm the progress of an insert stack along the insert conveyor 22. A stack progresses through the insert dispenser 28 until sensor 70 is interrupted, indicating an insert stack (182 in FIG. 2E) is proximate the dispensing end of the insert dispenser whereupon the insert dispenser 28 and conveyor 22 stop. When processor 72 sends a demand signal to the insert dispenser, the dispenser rapidly accelerates to fire a stack of inserts into an aligned envelope. The insert dispenser then continues to feed until a next stack of inserts is proximate its dispensing end.

The insert conveyor 22 and its associated devices, the card reader, the insert feeders, and the insert dispenser may normally be operated at a higher speed than the envelope feeder. This is due to the need to index the carrousel, whereas the conveyor 22 and insert dispenser are capable of running continuously. In consequence, it can be ensured that an insert stack will reach the dispensing end of the insert dispenser early, or just-in-time.

If, as a result of reading information from the envelope and the card which will be fed to the envelope, the processor discovers there is a mis-match, i.e., the card is not intended for the envelope, the processor may track the envelope in question and control solenoid 50 to ensure that its flap is not closed as it passes through the selective flap folding section 46 of the unloading conveyor. The left open envelope is a flag to quality control personnel that there is a problem with the particular filled envelope and it needs to be manually checked.

Similarly, if a sensor 60a, 60b, or 60c indicates an insert did not feed in response to a demand, the processor 72 may ensure the envelope filled with the resulting insert stack is left open so that it will be manually checked.

The processor may also leave random, or periodic, filled envelopes open for a quality check.

If a card does not feed, as sensed by sensor 58 or 62, or if an insert stack is not sensed by sensor, the processor will normally stop system 10 and output an alarm since to continue is likely to result in a perpetual mis-match of cards and envelopes. The same may hold if a pre-printed envelope does not feed. Alternatively, if a card is fed before the corresponding envelope, then, on a card mis-feeding, envelope feeder 24 may be controlled by processor 72 to inhibit the feeding of the corresponding envelope so that the system continues by feeding the next card and envelope.

It will be apparent that, by virtue of abutments 120, 122 being carried by arms which may slide on rods 128, the distance between the abutments is adjustable in order to fine tune the degree to which an envelope is held open.

Instead of providing an ordered stack of pre-printed envelopes, a stack of unordered blank envelopes may be used where printer 30 is provided. In this instance, responsive to reader 68 passing information from a card to the processor, the processor can control printer 30 to print corresponding information on the envelope into which the card will be inserted.

Of course, system 10 may be used to stuff envelopes with inserts other than gift cards, in which case the insert conveyor 22 and its associated devices may need to be changed.

With appropriate progressive flared ends of abutments 120, 122, the edges of an envelope could be progressively deflected to open out the envelope. In such instance, it may be possible to dispense with the vacuum source and the air jets.

Other modifications will be apparent to those skilled in the art and, therefore, the invention is defined in the claims.

What is claimed is:

1. An envelope stuffer comprising:
a carrousel having opposed first and second side walls and a plurality of envelope receivers;
a pair of opposed abutments supported inwardly of said first and second carrousel side walls and extending along an arc of said first and second carrousel side walls, an upstream end of at least one abutment of said pair of abutments flaring outwardly away from another abutment of said pair of abutments.

2. The stuffer of claim 1 further comprising a radial slot in said first side wall of said carrousel aligned with each of said envelope receivers.

3. The stuffer of claim 2 wherein each of said envelope receivers of said carrousel further comprise:
a first V-shaped envelope support extending inwardly from said first side wall and narrowing toward said first side wall, a narrow end of said first envelope support defining a gap aligned with said slot; and
a second V-shaped envelope support opposed to said first V-shaped envelope support and extending inwardly from said second side wall.

4. The stuffer of claim 3 wherein said first envelope support comprises a pair of plates and wherein said second envelope support comprises a pair of plates.

5. The stuffer of claim 4 further comprising a base extending between said first and second carrousel side walls, said base defining a slot for confining and supporting a base of an envelope.

6. The stuffer of claim 1 further comprising a loading conveyor for conveying envelopes to said carrousel, said abutments positioned such that envelopes conveyed by said carrousel away from said loading conveyor are conveyed between said abutments.

7. The stuffer of claim 6 wherein said abutments terminate at said loading conveyor.

8. The stuffer of claim 7 further comprising an upwardly directed vacuum source extending between said first and second side walls of said carrousel below said abutments.

9. The stuffer of claim 8 further comprising an air jet between said first and second side walls of said carrousel directed so as to direct air into a throat of an envelope received by one of said envelope receivers.

10. The stuffer of claim 6 wherein each of said envelope receivers of said carrousel further comprise:
a first V-shaped envelope support extending inwardly from said first side wall and narrowing toward said first side wall, a narrow end of said first envelope support defining a gap aligned with said slot; and
a second V-shaped envelope support opposed to said first V-shaped envelope support and extending inwardly from said second side wall.

11. The stuffer of claim 2 further comprising an unloading conveyor for conveying envelopes from said carrousel, said unloading conveyor having a selective flap folder.

12. The stuffer of claim 11 wherein said selective flap folder comprises a pivoting plate and a plough, said pivoting plate having a first position establishing a flap feed path which bypasses said plough and a second position establishing a flap feed path which incorporates said plough.

13. The stuffer of claim 12 further comprising an actuator for pivoting said plate to said first position and to said second position.

14. The stuffer of claim 13 further comprising an insert dispenser having a discharge end directed toward said carrousel so as to discharge inserts between said pair of opposed abutments.

15. The stuffer of claim 14 further comprising:
an insert mis-feed indicator associated with said insert conveyor; and
a processor operatively connected to said mis-feed indicator and to said actuator;
said processor for controlling said actuator so that said pivot plate assumes said first position after receiving a mis-feed signal from said mis-feed indicator such that an envelope into which has been discharged inserts that generated said mis-feed signal bypasses said plough.

16. The stuffer of claim 15 further comprising:
a motor for indexing said carrousel;
a second actuator for operating said insert dispenser; and
a processor operatively connected to said motor and said second actuator for controlling said motor and said insert dispenser so that inserts are discharged into envelopes.

17. An envelope flap folder comprising:
a plough;
a pivoting plate upstream of said plough, said pivoting plate having a first position establishing a first flap feed path which bypasses said plough and a second position establishing a second flap feed path which incorporates said plough; and
an actuator for pivoting said plate between said first position and said second position.

18. The flap folder of claim 17 wherein said plate declines in moving from said first position to said second position such that said first flap feed path extends over said plough and said second flap feed path extends below said plough.

19. A method of stuffing an envelope comprising:
feeding an envelope into an envelope receiver of a carrousel having opposed first and second side walls and a plurality of envelope receivers;
rotating said carrousel so that edges of said envelope are contacted by a pair of opposed abutments supported inwardly of said first and second carrousel side walls so that said edges are held inwardly deflected so that said envelope is opened; and
feeding inserts into said envelope while opened.

20. The method of claim 19 further comprising:
temporarily opening said envelope, and thereby drawing edges of said envelope inwardly with at least one of a vacuum and an air jet as said carrousel is rotated to a position whereat said edges of said envelope are held inwardly deflected by said pair of opposed abutments.
